(19) United States
(12) Patent Application Publication
(10) Pub. No.: US 2006/0203703 A1
(43) Pub. Date: Sep. 14, 2006

(54) Information recording medium, recording/reproducing apparatus, and recording/reproducing method

(75) Inventors: Sung-hee Hwang, Suwon-si (KR); Jung-wan Ko, Suwon-si (KR); Kyung-geun Lee, Seongnam-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/367,369

(22) Filed: Mar. 6, 2006

(30) Foreign Application Priority Data
Mar. 14, 2005 (KR) 2005-21096

(51) Int. Cl. G11B 7/24

(52) U.S. Cl. 369/275.3

(57) ABSTRACT

An information recording medium, a recording/reproducing apparatus, and a recording/reproducing method where the recording/reproducing apparatus includes: a writing/reading unit that writes data to an information recording medium or reads data from the information recording medium; and a control unit that controls the writing/reading unit to write recording mode information indicating that the information recording medium is used in a logical overwrite (LOW) manner for updating data recorded in the information recording medium in a predetermined area of the information recording medium at the time of manufacturing the information recording medium. Accordingly, it is possible to distinguish a recording medium employing the LOW recording mode from a recording medium not employing the LOW recording mode, when the LOW recording mode is introduced into the information recording medium.

### CROSS-REFERENCE TO RELATED APPLICATIONS

This application claims the benefit of Korean Patent Application No. 2005-21096, filed on Mar. 14, 2005 in the Korean Intellectual Property Office, the disclosure of which is incorporated herein by reference.

### BACKGROUND OF THE INVENTION

1. Field of the Invention

An aspect of the present invention relates to a disk, and more particularly, to an information recording medium, a recording/reproducing apparatus, and a recording/reproducing method, for managing a recording mode.

2. Description of the Related Art

In a rewritable information recording medium, a spare area is generally allocated in a part of a data area so as to manage defects. That is, when defects occur in the course of recording user data in a user data area (an area of the data area other than the spare area) or reproducing the data recorded in the user data area, replacement data for replacing the defect data is written in the spare area.

In addition, in a write-once information recording medium, a defect managing method is used for a logical overwrite (LOW). A “logical overwrite” is a method of rewriting data in the write-once information recording medium. That is, in order to update the data already recorded in a user data area, the recorded data is treated as if it is defective data and data for replacing the recorded data is recorded in a non-recorded area. In this way, by fixing a logical address of the data recorded in the user data area and using a physical address corresponding to the logical address as an address of the replacement data, the host can be made to recognize that the data of the user data area is rewritten at the same position, thereby facilitating defect management. This is because the host is associated with only the logical address.

Now, a replacement by LOW will be described in brief with reference to the drawings.

FIG. 1 is an explanatory diagram illustrating a conventional replacement by LOW.

Referring to FIG. 1, when the host issues a write command to physical spaces P1, P2, and P3 in a recording medium so as to update data blocks A1, A2, and A3 with data blocks B1, B2, and B3, respectively, based on the LOW in a state where A1, A2, and A3 are recorded in the physical spaces P1, P2, and P3 in the recording medium, the drive system updates the data blocks B1, B2, and B3 into physical spaces P4, P5, and P6 in the user data area of the recording medium using the replacement by LOW and generates a replacement entry indicating a state where P1, P2, and P3 are replaced with P4, P5, and P6, respectively.

Next, when the host gives read command for the logical address corresponding to the original physical spaces P1, P2, and P3, in order to read the data B1, B2, and B3, the drive system reproduces the data recorded in P4, P5, and P6 of the recording medium from the replacement entry and transmits the reproduced data to the host.

On the other hand, in a write-once information recording medium and a recording apparatus such as a conventional DVD-R, the user data area of the disk is divided into one or more R-zones to record data, and the disk is used in a disk-at-once (one R-zone) mode or a sequential recording mode in which data can be continuously written in the respective R-zones.

With an increase in demand for higher disk density, high-density disks having 15 GB to 25 GB capacity have arrived on the market. Such high density write-once information recording media, have been tried in a sequential recording mode due to the increase in recordable capacity and have been used as if they are rewritable recording media using the logical overwrite method.

Therefore, since a new recording method such as the logical overwrite can be applied to conventional write-once information recording media, it is necessary to distinguish the different recording methods when using these media.

### SUMMARY OF THE INVENTION

An aspect of the present invention provides an information recording medium, a recording/reproducing apparatus, and a recording/reproducing method, which can distinguish a disk used in a LOW recording mode from a disk not used in the LOW recording mode.

According to an aspect of the present invention, there is provided an information recording medium in which recording mode information, indicating that the information recording medium is used in a logical overwrite manner for updating data recorded in the information recording medium, is recorded in a predetermined area of the information recording medium at the time of manufacturing the information recording medium.

According ton another aspect of the present invention, the recording mode information may be stored in a pre-recorded area located in an inner circumferential portion of the information recording medium.

According to another aspect of the present invention, there is provided an information recording medium in which a recording mode for the information recording medium is recorded in a predetermined area of the information recording medium at the time of initializing the information recording medium, wherein the information recording medium is used in a plurality of recording modes including a logical overwrite (LOW) recording mode for updating data recorded in the information recording medium.

According to another aspect of the present invention, recording mode information may be recorded as status information in recording management data (RMD) of the information recording medium. The recording management data may be recorded in a first recordable area of a recording management area (RMA).

According to another aspect of the present invention, there is provided an information recording medium including a plurality of recording modes including a logical overwrite (LOW) recording mode, indicating that data can be replaced using a logical overwrite action for updating data recorded in the information recording medium, and a multi-border recording mode where the information recording medium can be used in a plurality of borders, wherein recording mode information for the borders is recorded in a predetermined area of the information recording medium at the time of initializing the borders.

According to another aspect of the present invention, the recording mode information may be recorded as status information in recording management data (RMD) of the information recording medium. The recording mode information may include at least one of information indicating that the borders are empty, information indicating that the borders are used in the recording modes other than the LOW recording mode, and information indicating that the borders are used in the LOW recording mode. Expressions of the form “at least one of A or B,” include A, B, A or B and A and B.

According to another aspect of the present invention, there is provided a recording/reproducing apparatus including: a writing/reading unit that writes data to an information recording medium or reads data from the information recording medium; and a control unit that controls the writing/reading unit to write recording mode information indicating that the information recording medium is used in a logical overwrite (LOW) manner for updating data recorded in the information recording medium in a predetermined area of the information recording medium at the time of manufacturing the information recording medium.

According to another aspect of the present invention, there is provided a recording/reproducing apparatus including: a writing/reading unit that writes data to an information recording medium or reads data from the information recording medium; and a control unit that controls the writing/reading unit to write a recording mode for the information recording medium in a predetermined area of the information recording medium at the time of initializing the information recording medium which can be used in a plurality of recording modes, including a logical overwrite (LOW) recording mode for updating data recorded in the information recording medium.

According to another aspect of the present invention, there is provided a recording/reproducing apparatus including: a writing/reading unit that writes data to an information recording medium or reads data from the information recording medium, in which a plurality of recording modes including a logical overwrite (LOW) recording mode indicating that data can be replaced by using a logical overwrite action for updating data recorded in an information recording medium and a multi-border where the information recording medium can be used in a plurality of borders are provided; and a control unit that controls the writing/reading unit to write recording mode information for the borders in a predetermined area of the information recording medium at the time of initializing the borders.

According to another aspect of the present invention, there is provided a recording method including: writing recording mode information in a predetermined area of a information recording medium at the time of manufacturing the information recording medium, the recording mode information indicating that the information recording medium is used in a logical overwrite (LOW) manner for updating data recorded in the information recording medium.

According to another aspect of the present invention, there is provided a recording method including: writing a recording mode for an information recording medium in a predetermined area of the information recording medium at the time of initializing the information recording medium which can be used in a plurality of recording modes including a logical overwrite (LOW) recording mode for updating data recorded in the information recording medium.

According to another aspect of the present invention, there is provided a recording method including: writing recording mode information for borders in a predetermined area of an information recording medium, in which a plurality of recording modes including a logical overwrite (LOW) recording mode indicating that data can be replaced by using a logical overwrite action for updating data recorded in the information recording medium and a multi-border where the information recording medium can be used in a plurality of borders are provided, at the time of initializing the borders.

According to another aspect of the present invention, there is provided a recording/reproducing apparatus including: a writing/reading unit that writes data in an information recording medium or reads data from the information recording medium; and a control unit that controls the writing/reading unit to read recording mode information, which indicates in which recording mode of a plurality of recording modes including a logical overwrite (LOW) recording mode in which data can be replaced by using a logical overwrite action for updating data recorded in the information recording medium the information recording medium is used, from a predetermined area of the information recording medium and to write data to the information recording medium or read data from the information recording medium in accordance with the read recording mode information.

According to another aspect of the present invention, the recording mode information may indicate one of a recording mode for the information recording medium and a recording mode for a border of the plurality of borders included in the information recording medium.

According to another aspect of the present invention, there is provided a recording/reproducing method including: reading recording mode information, which indicates in which recording mode of a plurality of recording modes including a logical overwrite (LOW) recording mode where data can be replaced by using a logical overwrite action for updating data recorded in an information recording medium the information recording medium is used, from a predetermined area of the information recording medium; and writing data to the information recording medium or reading data from the information recording medium in accordance with the read recording mode information.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an explanatory diagram illustrating a conventional logical overwrite-based replacement;

FIG. 2 is a schematic block diagram illustrating a recording/reproducing apparatus according to an embodiment of the present invention;

FIG. 3 is a detailed block diagram of the recording/reproducing apparatus illustrated in FIG. 2;

FIG. 4 is a structural diagram of an information recording medium illustrating a multi-border form of the information recording medium according to an embodiment of the present invention;

FIG. 5 is a structural diagram illustrating a recording management area (RMA) of the information recording medium of FIG. 4 according to an embodiment of the present invention;

FIG. 6 illustrates an RMD format according to an embodiment of the present invention;

FIG. 7 illustrates an RMD format according to another embodiment of the present invention;

FIG. 8 illustrates an example of RMD recording applied using the format illustrated in FIG. 7;

FIG. 9 illustrates another example of the RMD recording applied to the embodiment shown in FIG. 7 according to another embodiment of the present invention;

FIG. 10 is a flowchart illustrating a method of recording the recording mode information at the time of manufacturing a disk according to an embodiment of the present invention;

FIG. 11 is a flowchart illustrating a method of recording the recording mode information at the time of initializing a disk according to an embodiment of the present invention; and

FIG. 12 is a flowchart illustrating a method of recording all the recording mode information at the time of initializing each border of a disk according to an embodiment of the present invention.

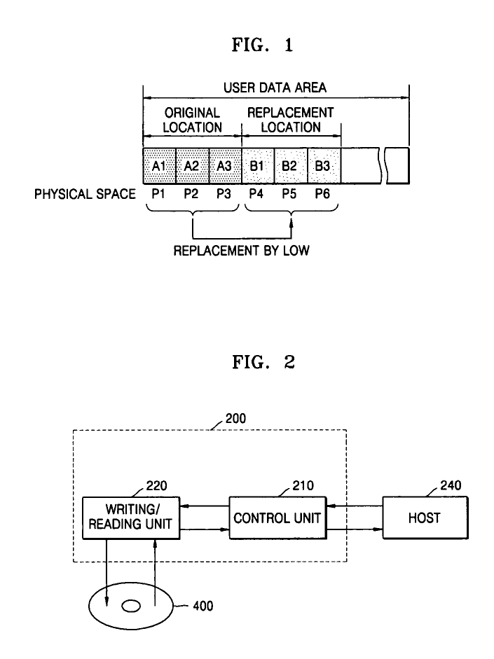

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

FIG. 2 is a schematic block diagram illustrating a recording/reproducing apparatus 200 according to an embodiment of the present invention.

Referring to FIG. 2, the recording/reproducing apparatus 200 is a writable or reproducible apparatus, and includes a writing/reading unit 220 and a control unit 210. The writing/reading unit 220 writes data to a disk 400, which is an information recording medium according to an embodiment of the present invention, under control of the control unit 210 and reads the written data to reproduce the data. The control unit 210 controls the writing/reading unit 220 to write data in predetermined recording unit blocks or to obtain effective data by processing the data read by the writing/reading unit 220.

Specifically, at the time of initializing the disk 400, the control unit 210 according to the current embodiment of the present invention controls the writing/reading unit 220 to write recording management data containing information of recording modes used for the disk 400 in a predetermined area of the disk 400.

In addition, when the disk 400 is used in a multi-border form, the control unit 210 controls the writing/reading unit 220 to write the recording management data containing the information of the recording modes used for the borders in a predetermined area of the disk 400 at the time of initializing the disk 400.

If the recording/reproducing apparatus is used as a recording apparatus at the time of manufacturing disks, the control unit 210 controls the writing/reading unit 220 to write the recording management data containing the information of the recording modes used for the disk 400 in a predetermined area of the disk 400 at the time of manufacturing the disk 400.

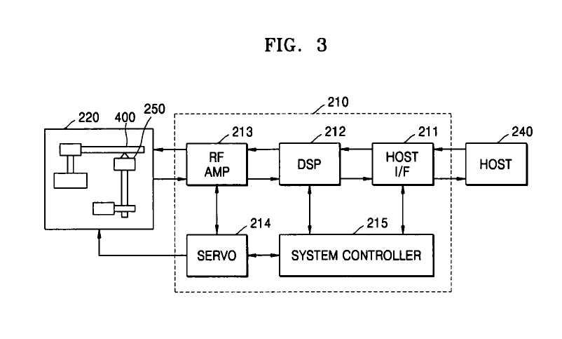

FIG. 3 is a detailed block diagram of the recording/reproducing apparatus illustrated in FIG. 2.

Referring to FIG. 3, the writing/reading unit 220 includes a pickup 250. The disk 400 is mounted on the pickup 250. The control unit 210 includes a host I/F 211, a DSP 212, an RF AMP 213, a servo 214, and a system controller 215.

At the time of initializing the disk 400, a host 240 allows a user to determine a recording mode used by the disk 400 through a user interface, etc., and transmits a disk initializing command to the host I/F 211 using the determined recording mode. At this time, the user determines whether the disk 400 should be used in a logical overwrite (LOW) mode or in other recording modes.

The host I/F 211 receives the disk initializing command from the host 240 and transmits the disk initializing command to the system controller 215.

The system controller 215 receives the disk initializing command from the host I/F 211 and initializes the disk.

Specifically, the system controller 215 controls the writing/reading unit 220 to generate recording management data using recording mode information received from the host 240 and to write the recording management data in a predetermined area of the disk 400.

When the disk 400 is in use, as well as when the disk 400 is initialized, if the disk 400 is used in the multi-border form, each border can be initialized at the time of starting each border.

That is, at the time of initializing each border of the disk 400, the host 240 allows the user to determine a recording mode used for each border through the user interface, etc., and transmits the border initializing command to the host I/F 211 using the determined recording mode. At this time, the user also determines whether the border is used in the LOW recording mode or in other recording modes. When no recording mode is determined, “empty” can be marked in the recording management data to indicate that no recording mode is determined.

The host I/F 211 receives the border initializing command from the host 240 and transmits the border initializing command to the system controller 215.

The system controller 215 receives the border initializing command from the host I/F 211 and initializes the borders. Specifically, the system controller 215, according to the current embodiment of the present invention, controls the writing/reading unit 220 to generate the recording management data using the recording mode information received from the host 240 and used for each border and controls the writing/reading unit 220 to write the recording management data in a predetermined area of the disk 400.

The DSP 212 adds additional data such as parity data/bits to the recording data received from the host I/F 211 for the purpose of error correction, ECC-encodes the data to generate an ECC block, which is an error correction block, and then modulates the ECC block in a predetermined way. The RF AMP 213 converts the data output from the DSP 212 into RF signals. The pickup 250 writes the RF signals output from the RF AMP 213 in the disk 400. The servo 214 receives an instruction necessary for servo control from the system controller 215 and servo-controls the pickup 250.

At the time of reproduction, the host I/F 211 receives a read command from the host 240. The system controller 215 performs initialization for reproduction.

According to the current embodiment of the present invention, the system controller 215 controls the writing/reading unit 220 to read the recording management data written in the predetermined area of the disk 400. Based on the recording management data, the system controller 215 controls the writing/reading unit 220 to determine the recording mode of the entire disk 400 or the recording mode used for each border when the disk 400 is used in a multi-border form and to read data recorded in the disk 400 or write data to the disk 400 in accordance with the respective recording modes.

The pickup 250 irradiates laser beams to the disk 400 and receives the laser beams reflected by the disk 400, thereby outputting optical signals. The RF AMP 213 converts the optical signals output from the pickup 250 into RF signals, supplies the modulated data obtained from the RF signals to the DSP 212, and supplies a servo control signal obtained from the RF signals to the servo 214. The DSP 212 demodulates the modulated data and outputs the data obtained through ECC error correction.

On the other hand, the servo 214 receives the servo control signal from the RF AMP 213 and an instruction necessary for the servo control from the system controller 215 and performs the servo control for the pickup 250. The host I/F 211 transmits the data received from the DSP 212 to the host 240.

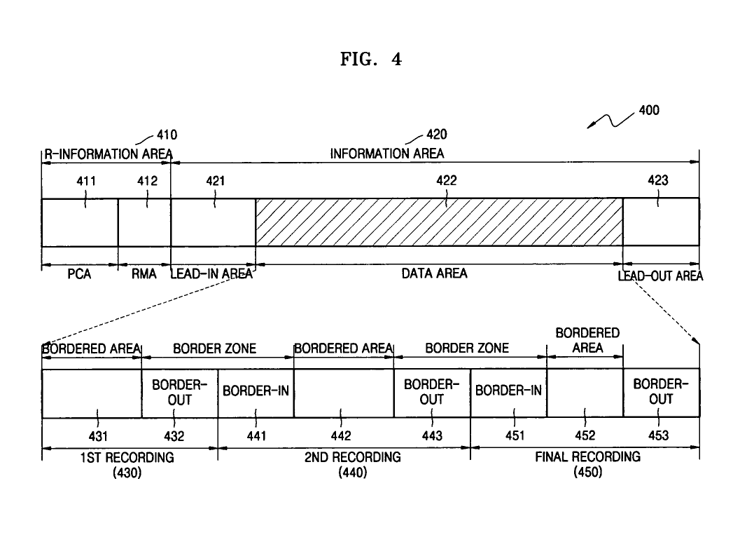

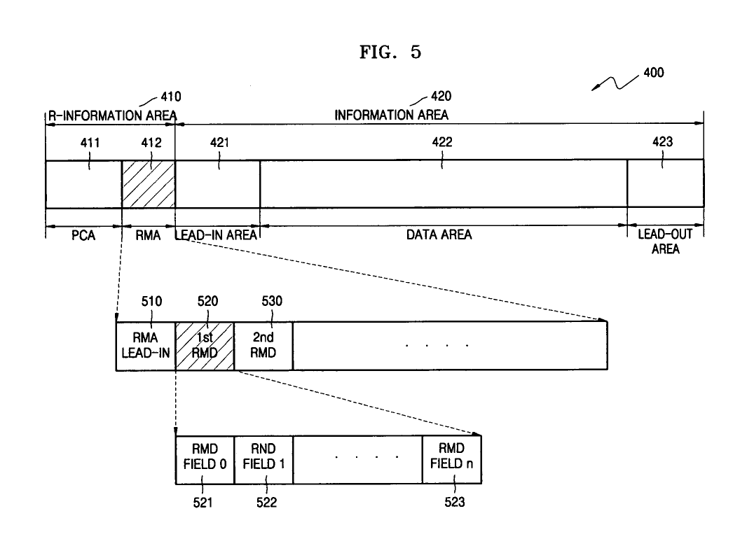

Before specifically describing an initialization method for identifying the disk used in the LOW recording mode and disks not used in the LOW recording mode according to an embodiment of the present invention, an example of the information recording medium according to an embodiment of the present invention will be described with reference to FIGS. 4 and 5.

FIG. 4 is a structural diagram of an information recording medium 400 illustrating a multi-border form of the information recording medium 400 according to an embodiment of the present invention.

Referring to FIG. 4, the information recording medium 400 includes an R-Information area 410 and an information area 420.

The R-information area 410 includes a power calibration area (PCA) 411 for calibrating power and testing the recording medium so as to obtain power suitable for the recording medium and a recording management area (RMA) 412 for recording, recording management data (RMD) containing information of the recording details of the recording medium.

The information area 420 includes a lead-in area 421 located in an inner circumferential portion of the information recording medium 400, a data area 422 for recording user data, and a lead-out area 423 located in an outer circumferential portion of the information recording medium 400

The data area 422 is an area for recording the user data and can be used in a single border form or in a multi-border form. The single border form means that the data area 422 is used in a single border and the multi-border form means that the data area 422 is used in multi borders. In FIG. 4, an example of the data area 422 used in the multi border form is illustrated.

Referring to FIG. 4, at the time of first recording, data is written in a bordered area 431, and a border-out portion 432 is generated to close the border, thereby forming a first border. At the time of second recording, data is written in a bordered area 442 from a border-in portion 441 and a border-out portion 443 is generated to close the border, thereby forming a second border. At the time of third recording, data is written in a bordered area 452 from a border-in portion 451 and a border-out portion 453 is generated to close the border, thereby forming a third border. A plurality of borders may be formed and used simultaneously. Alternatively, the borders may be constructed such that only a current border is opened and used at the specific time of the recording, the current border is closed at the time of ending the recording, and a next border is then opened for use in the next recording.

An area including the border-out portion and the border-in portion is referred to as a border zone.

The structure of the information recording medium illustrated in FIG. 4 is only one example of the structure of an information recording medium according to the present invention and thus the present invention is not limited thereto. The structure of the information recording medium according to the present invention may be changed in various forms.

FIG. 5 is a structural diagram illustrating a recording management area (RMA) 412 of the information recording medium 400 of FIG. 4 according to an embodiment of the present invention.

Referring to FIG. 5, in the recording management area (RMA) 412, an RMA lead-in area 510 is provided at the start to record recording management data (RMD), and one or more pieces of RMD are written in the area next to the RMA lead-in area 510. In FIG. 5, a first RMD 520 and a second RMD 530 are illustrated.

Each RMD is composed of a plurality of RMD fields. For example, the first RMD 520 includes an RMD field 0 521, an RMD field 1 522, . . . , and an RMD field n 523. Here, the number of RMD fields included in one RMD, that is, “n,” can be set to various values.

As the initialization method for identifying a disk to be used in the LOW recording mode and other disks according to an embodiment of the present invention, an identification method at the time of manufacturing a disk, an identification method at the time of initializing a disk, and an identification method at the time of initializing each border when the disk is used in a multi border form are provided.

(Identification Method at the Time of Manufacturing Disk)

Generally, a write-once information recording medium is manufactured in a state where information on a disk is recorded in a predetermined recording area of the disk at the time of manufacturing the disk. Such information on the disk is information specific to the disk and is not changed in use thereof.

Therefore, for the purpose of solving confusion due to recording modes different from each other such as a LOW recording mode and other recording modes at the time of manufacturing a disk, information on versions varying by disks, or information that the disk should be used only in a sequential recording mode or only in the LOW recording mode can be recorded in a predetermined area of the disk at the time of manufacturing the disk, thereby identifying the disks having different recording modes.

(Identification Method at the Time of Initializing Disk)

The method of manufacturing a disk by determining a recording mode of the disk at the time of manufacturing the disk has a disadvantage that the recording mode is restricted by disks. If a user is allowed to select a recording mode at the time of initializing a disk, the applicability of the disk is widened. Since the sequential recording mode and the LOW recording mode have different logical recording methods but can be used on similar disks, a disk can be used both in the sequential recording mode and in the LOW recording mode.

Accordingly, an aspect of the present invention provides an initialization process allowing a user to select a recording mode at the time of initializing a disk.

At the time of initializing the disk, when the user determines a recording mode for the disk, the drive system generates the recording management data corresponding to the recording mode determined by the user and writes recording management data in the recording management area.

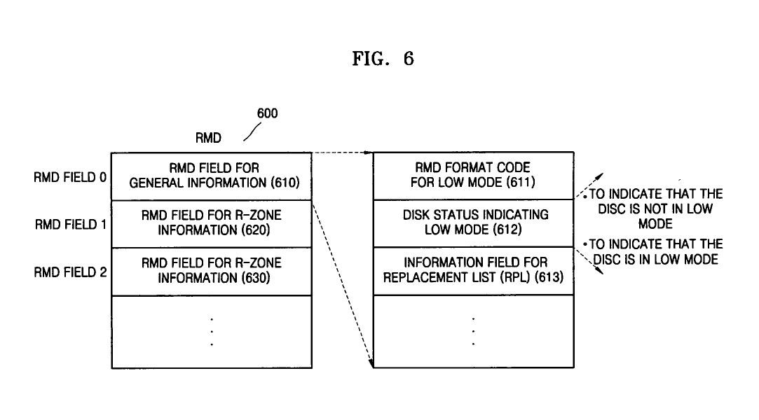

FIG. 6 illustrates an RMD format according to an embodiment of the present invention, when a recording mode of a disk is set to the LOW recording mode at the time of manufacturing or initializing the disk and the recording mode is not changed until the disk is finalized. The RMD format includes one or more RMD fields and each RMD field includes information fields corresponding to the characteristic of the RMD field.

Referring to FIG. 6, an RMD field 0, of an RMD 600, denotes an RMD field 610 for general information, an RMD field 1 denotes an RMD field 620 for R-zone information, and an RMD field 2 denotes an RMD field 630 for R-zone information.

The RMD field 610 for general information includes an RMD format code 611 for a LOW recording mode, a disk status field 612 for a LOW recording mode, and an information field 613 for a replacement list (RPL).

The RMD format code 611 for the LOW recording mode may include a specific RMD format code value for the LOW recording mode so as to distinguish it from other RMD format codes for recording modes different in RMD format.

The disk status field 612 for the LOW recording mode is set to a disk status indicating the LOW recording mode.

In order to indicate other recording modes used by the disk including the LOW recording mode, status information or values indicating the following information can be set.

To indicate that a disk is in LOW mode

This is status information indicating that the disk is used in the LOW recording mode.

To indicate that a disk is not in LOW mode

This means that the disk is not used in the LOW recording mode. Here, “To indicate that a disk is not in LOW recording mode” may be used as information indicating whether the disk is used in a disk-at-once recording mode or in the sequential recording mode, like the disk status of RMD field 0 in the RMD format of the DVD-R.

When the disk is initialized in the LOW recording mode, the “disk status” of the RMD field for general information in the RMD format recorded in a first usable area of the RMA is set to a value of “To indicate that the disc is in LOW mode” so as to indicate that the disk is initialized in the LOW recording mode and is used in the LOW recording mode.

The information field 613 for the replacement list (RPL) represents a field containing information on a replacement list (RPL) and may include information on a location in which the replacement by LOW list (RPL) is recorded or information on the number of RPL blocks additionally used or in use. The replacement list (RPL) is a list containing information on the replacement by LOW. For example, the replacement list (RPL) may include information on original blocks for the replacement by LOW and information on replacement blocks for the replacement by LOW.

Although not illustrated in FIG. 6, a space for additionally recording the replacement list (RPL) itself may be included in the RMD format for LOW.

In this way, by varying the disk status information of the RMD format in accordance with the different recording modes, it is possible to confirm in which recording mode a disk is used or would be used when the disk is loaded. The method of determining a recording mode of the disk at the time of initializing the disk cannot be changed when the recording medium is used in a single border form or when the recording medium is used in a multi-border form but the recording mode thereof is determined at the time of initializing the disk.

(Identification Method at the Time of Initializing Each Border of a Multi-Border)

When a disk is used in a multi-border form, the recording modes for the respective borders can be identified by determining the recording modes for the respective borders at the time of initializing the respective borders. Accordingly, the RMD format may include border statuses for indicating status information on the borders, like the disk status mentioned above.

A recording mode of a border may be determined at the start of the border. In addition, the RMD containing the information on the recording mode determined for the border may be written in a next recordable area of the RMA. If one or more borders that can be simultaneously used exist in the recording medium, the border status information is required as much as the number of borders, which can be simultaneously used.

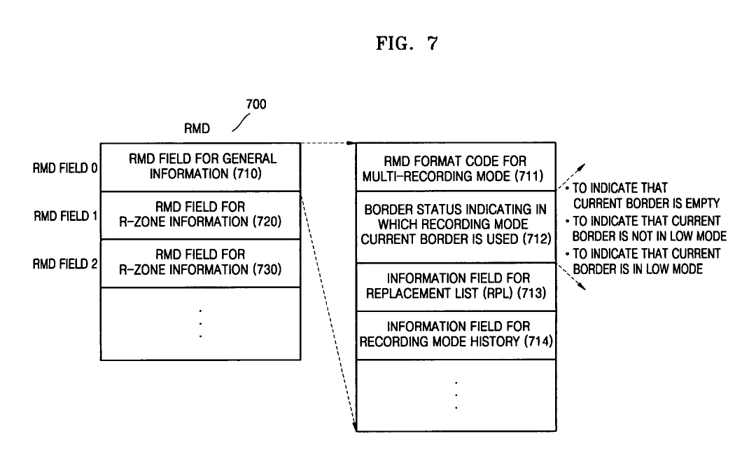

FIG. 7 illustrates an RMD format according to another embodiment of the present invention, where a recording mode is determined at the time of initializing a border and the determined recording mode is indicated.

Referring to FIG. 7, in an RMD 700, an RMD field 0 denotes an RMD field 710 for general information, an RMD field 1 denotes an RMD field 720 for R-zone information, and an RMD field 2 denotes an RMD field 730 for R-zone information.

The RMD field 710 for general information includes an RMD format code 711 for a multi-recording mode, a border status field 712 indicating in which recording mode the current border is used, an information field 713 for a replacement list (RPL), and an information field 714 for recording mode history.

The RMD format code 711 for the multi-recording mode may have a specific RMD format code value for the multi-recording mode to differentiate it from the RMD format codes with other recording modes because a disk can be used in a plurality of recording modes.

The border status field 712 is used to indicate in which recording mode the current border of the disk is used and may have the following status information.

To indicate that the current border is empty

This is status information indicating that no recording mode is determined for the border and that the border is empty.

To indicate that the current border is not in LOW mode

This is status information indicating that the border is used in a recording mode other than the LOW recording mode. The information, “To indicate that the current border is not in LOW code”, means the sequential recording mode, when two recording modes, that is, a LOW recording mode and a sequential recording mode are used.

To indicate that the border is in LOW mode

This is status information indicating that the border is used in the LOW recording mode.

The information field 713 for RPL may include information on the position in which the replacement list (RPL) is recorded when the border is used in the LOW recording mode or information on the number of blocks additionally used or in use.

The information field 714 for recording mode history includes history information on the recording modes for the respective borders used in the disk or the recording modes indicating if the LOW recording mode has ever been used.

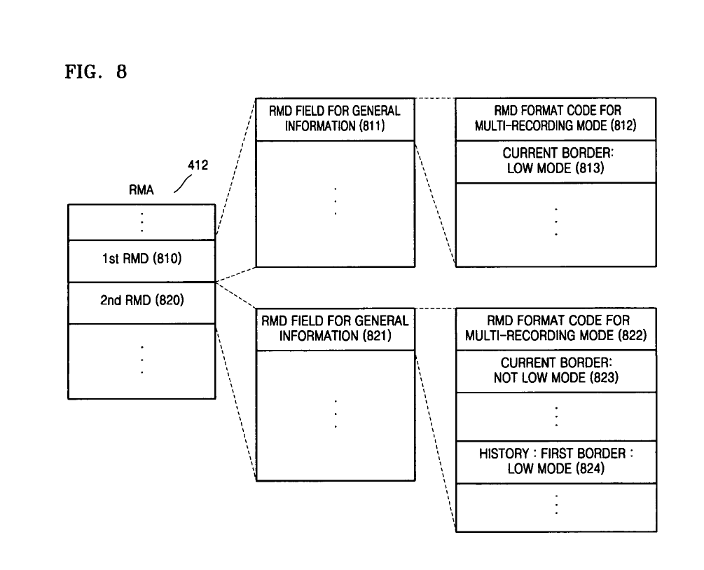

FIG. 8 illustrates an example of RMD recording applied to the RMA412 using the RMD format illustrated in FIG. 7.

Referring to FIG. 8, a first RMD 810 and a second RMD 820 are recorded in the RMA 412.

An RMD field 811 for general information in the first RMD 810 includes an RMD format code 812 for a multi-recording mode and a border status information field 813 indicating that the current border is used in a LOW recording mode.

An RMD field 821 for general information in the second RMD 820 includes an RMD format code 822 for the multi-recording mode, border status information 823 indicating that the current border is not used in the LOW recording mode, and information indicating that the first border is used in the LOW recording mode, and history information 824 on the recording mode.

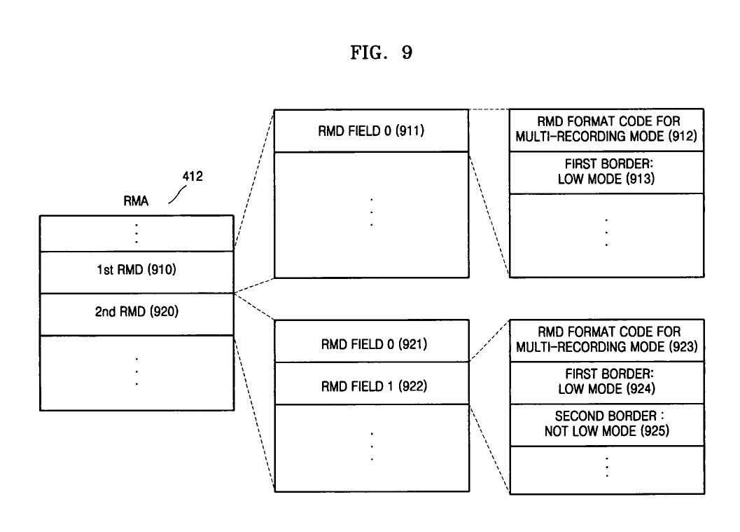

FIG. 9 illustrates another example of the RMD recording applied to the RMA 412 using the RMD format illustrated in FIG. 7, where an RMD field for the status information of each border is added to the RMD format.

Referring to FIG. 9, a first RMD 910 and a second RMD 920 are recorded in the RMA 412.

An RMD field 0 911 of the first RMD 910 includes an RMD format code 912 for a multi-recording mode and a border status information field 913 indicating that the first border is used in a LOW recording mode.

An RMD field 1 922 added to the second RMD 920 includes a border status 923 where the second border is not used in the LOW recording mode.

That is, like the disk status indicating the status information on the disk, the border status information in the RMD field may indicate whether each border is empty or in which recording mode each border is used (in case of a border in use) or has been used (in case of a border closed). Of course, the border status information indicates the status information of all the borders in the disk.

Although not shown, the RMD format for LOW illustrated in FIG. 7 may further include a space for storing the replacement list (RPL). In DVD-R, the size of RMD is one block (16 sectors), but when the recording/reproducing unit block has 32 sectors, the size of RMD may be 32 sectors. However, when the RMD format includes an area for the replacement list (RPL), the RMD may include a plurality of recording/reproducing unit blocks.

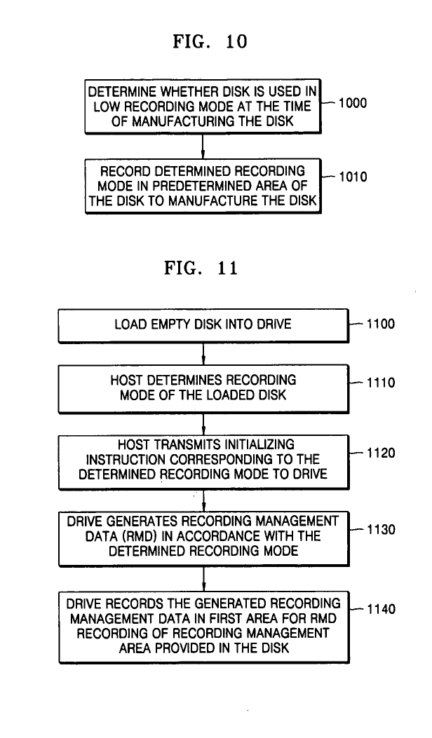

FIG. 10 is a flowchart illustrating a method of recording all recording mode information at the time of manufacturing a disk according to an embodiment of the present invention.

At the time of manufacturing a disk, it is determined whether the disk is used in a LOW recording mode (1000). This operation is performed at the time of manufacturing the disk, and a user cannot change the recording mode of the disk thereafter.

The determined recording mode is recorded in a predetermined area of the disk (1010).

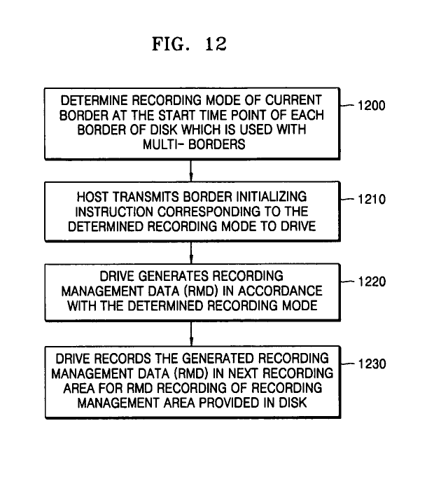

FIG. 11 is a flowchart illustrating a method of recording all the recording mode information at the time of initializing a disk according to an embodiment of the present invention.

An empty disk on which data is to be recorded is loaded in a drive (1100).

A host determines a recording mode of the loaded disk (1110). The user determines the recording mode for the disk using a variety of interfaces provided by the host.

The host transmits the initializing command corresponding to the determined recording mode to the drive (1120).

Then, the drive generates recording management data (RMD) corresponding to the determined recording mode (1130). An example of the recording management data (RMD) indicating that the recording mode is determined at the time of initializing or manufacturing the disk has been described with reference to FIG. 6.

Then, the drive records the generated recording management data (RMD) in a recording management area (RMA) provided in the disk (1140). The RMA may be assigned to an R-information area further inside the lead-in area like DVD-R, or may be assigned to a recordable area of the lead-in area.

FIG. 12 is a flowchart illustrating a method of recording all the recording mode information at the time of initializing each border of a disk according to an embodiment of the present invention.

At the start of each border of the disk which is used in a multi-border form, a host determines the recording mode of the current border (1200). Similarly to the initialization of the disk, the user determines the recording mode for the current border of the disk using a variety of interfaces provided by the host.

The host transmits the border initializing command corresponding to the determined recording mode to a drive (1210).

Then, the drive generates recording management data (RMD) corresponding to the determined recording mode. An example of recording management data indicating that the recording mode is determined for each border has been described with reference to FIGS. 7 to 9.

Next, the drive writes the generated recording management data in a next writable area for RMD recording in a recording management area (RMA) in the disk (1230).

The recording or reproducing method described above can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for embodying the recording or reproducing method can be easily construed by programmers skilled in the art to which the present invention pertains.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

According to an aspect of the present invention, it is possible to distinguish a recording medium used in a LOW recording mode from a recording medium not used in the LOW recording mode when a LOW recording mode is introduced into an information recording medium. In addition, by allowing a user to determine the recording mode for the recording medium at the time of initializing the recording medium or the borders, it is possible to enhance the applicability of the information recording medium.

What is claimed is:

1. An information recording medium comprising:
recording mode information indicating that the information recording medium is used in a logical overwrite manner for updating data recorded in the information recording medium,
wherein the recording mode information is recorded in a predetermined area of the information recording medium at the time of manufacturing the information recording medium.

2. The information recording medium of claim 1, wherein the recording mode information is stored in a pre-recorded area located in an inner circumferential portion of the information recording medium.

3. An information recording medium comprising:
a recording mode of the information recording medium recorded in a predetermined area of the information recording medium at the time of initializing the information recording medium,
wherein the information recording medium is used in a plurality of recording modes comprising a logical overwrite (LOW) recording mode for updating data recorded in the information recording medium.

4. The information recording medium of claim 3, wherein recording mode information is recorded as status information in recording management data (RMD) of the information recording medium.

5. The information recording medium of claim 4, wherein the recording management data (RMD) comprising the recording mode information is recorded in a first recordable area of a recording management area (RMA).

6. An information recording medium comprising:
a logical overwrite (LOW) recording mode indicating that data is replaced using a logical overwrite action for updating data recorded in the information recording medium, and
a multi-border recording mode where the information recording medium is used with a plurality of borders,
wherein recording mode information of the borders is recorded in a predetermined area of the information recording medium at the time of initializing the borders.

7. The information recording medium of claim 6, wherein the recording mode information is recorded as status information in recording management data (RMD) of the information recording medium.

8. The information recording medium of claim 7, wherein the recording mode information includes at least one of information indicating that the borders are empty, information indicating that the borders are used in one of the recording modes other than the LOW recording mode, and information indicating that the borders are used in the LOW recording mode.

9. A recording/reproducing apparatus comprising:
a writing/reading unit that writes data to an information recording medium or reads the data from the information recording medium; and
a control unit that controls the writing/reading unit to write recording mode information in a predetermined area of the information recording medium at the time of manufacturing the information recording medium, the recording mode information indicating that the information recording medium is used in a logical overwrite (LOW) manner for updating data recorded in the information recording medium.

10. The recording/reproducing apparatus of claim 9, wherein the recording mode information is stored in a pre-recorded area located in an inner circumferential portion of the information recording medium.

11. A recording/reproducing apparatus comprising:
a writing/reading unit that writes data to an information recording medium or reads data from the information recording medium; and
a control unit that controls the writing/reading unit to write a recording mode of the information recording medium in a predetermined area of the information recording medium at the time of initializing the information recording medium which is used in a plurality of recording modes comprising a logical overwrite (LOW) recording mode for updating data recorded in the information recording medium.

12. The recording/reproducing apparatus of claim 11, wherein recording mode information is written as status information in recording management data (RMD) of the information recording medium.

13. The recording/reproducing apparatus of claim 12, wherein the control unit further controls the writing/reading unit to write the recording management data (RMD) comprising the recording mode information in a first recordable area of a recording management area (RMA).

14. A recording/reproducing apparatus comprising:
a writing/reading unit that writes data to an information recording medium or reads the data from the information recording medium, in which a plurality of recording modes are recorded in a predetermined area of the information recording medium, the recording modes comprising a logical overwrite (LOW) recording mode and a multi-border recording mode, the LOW recording mode indicating that the data recorded in the information recording medium is replaced using a logical overwrite action and the multi-border recording mode indicating the information recording medium includes a plurality of borders; and
a control unit that controls the writing/reading unit to write recording mode information for the plurality of borders in a predetermined area of the information recording medium at the time of initializing the plurality of borders.

15. The recording/reproducing apparatus of claim 14, wherein the recording mode information is written as status information in recording management data (RMD) of the information recording medium.

16. The recording/reproducing apparatus of claim 15, wherein the recording mode information comprises at least one of information indicating that the borders are empty, information indicating that the borders are used in one of the recording modes other than the LOW recording mode, and information indicating that the borders are used in the LOW recording mode.

17. A recording method comprising:
writing recording mode information indicating that an information recording medium is used in a logical overwrite (LOW) manner for updating data recorded in the information recording medium,
wherein the recording mode information is written in a predetermined area of the information recording medium at the time of manufacturing the information recording medium.

18. The recording method according to claim 17, wherein the recording mode information is stored in a pre-recorded area located in an inner circumferential portion of the information recording medium.

19. A recording method comprising:
recording a recording mode information for an information recording medium in a predetermined area of the information recording medium at the time of initializing the information recording medium used in a plurality of recording modes, the recording modes comprising a logical overwrite (LOW) recording mode for updating data recorded in the information recording medium.

20. The recording method of claim 19, wherein the recording mode information is recorded as status information in recording management data (RMD) of the information recording medium.

21. The recording method of claim 20, wherein the writing of the recording mode for the information recording medium further comprises:
writing the recording management data (RMD) comprising the recording mode information in a first recordable area of a recording management area (RMA).

22. A recording method comprising:
writing recording mode information of borders in a predetermined area of an information recording medium at the time of initializing the borders, in which a plurality of recording modes comprising a logical overwrite (LOW) recording mode, indicating that data is replaced using a logical overwrite action for updating data recorded in the information recording medium, and a multi-border recording mode where the information recording medium is used in a plurality of borders are provided.

23. The recording method of claim 22, wherein the recording mode information is recorded as status information in recording management data (RMD) of the information recording medium.

24. The recording method of claim 23, wherein the recording mode information comprises at least one of information indicating that the borders are empty, information indicating that the borders are used in one of the recording modes other than the LOW recording mode, and information indicating that the borders are used in the LOW recording mode.

25. A recording/reproducing apparatus comprising:
a writing/reading unit that writes data to an information recording medium or reads data from the information recording medium; and
a control unit that controls the writing/reading unit to read recording mode information and to write data to the information recording medium or read data from the information recording medium in accordance with the read recording mode information,
wherein the recording mode information indicates in which recording mode of a plurality of recording modes the information recording medium is used, the recording mode information comprising a logical overwrite (LOW) recording mode, in which data is replaced using a logical overwrite action for updating data recorded in a predetermined area of the information recording medium.

26. The recording/reproducing apparatus of claim 25, wherein the recording mode information indicates one of a recording mode of the information recording medium and a recording mode of a border of the plurality of borders included in the information recording medium.

27. A recording/reproducing method comprising:
reading recording mode information, from a predetermined area of an information recording medium, which indicates in which recording mode of a plurality of recording modes the information recording medium is used, the plurality of recording modes comprising a logical overwrite (LOW) recording mode where data is replaced using a logical overwrite action for updating data recorded in the information recording medium; and
recording data to the information recording medium or reading data from the information recording medium in accordance with the read recording mode information.

28. The recording/reproducing method of claim 27, wherein the recording mode information indicates one of the recording modes of the information recording medium and the recording mode for a border of a plurality of borders included in the information recording medium.

29. The recording method of claim 19, wherein a user selects the recording mode of the information recording medium at the time of initializing the information recording medium.

30. The recording method of claim 21, wherein the RMA includes an RMA lead-in area and a plurality of RMD fields.

31. The recording method of claim 21, wherein when the user determines the recording mode of the information recording medium, the recording management data (RMA) corresponding to the recording mode determined by the user is generated and the generated recording management data is written on the information recording medium.
